(19) United States
(12) Patent Application Publication
(10) Pub. No.: US 2015/0328584 A1
(43) Pub. Date: Nov. 19, 2015

(54) LAMINATED BLOTTER HUMIDITY CONTROL

(71) Applicant: BOVEDA, INC., Wayzata, MN (US)

(72) Inventors: David C. Egberg, Bonita Springs, FL (US); Robert L. Esse, Monticello, MN (US)

(73) Assignee: BOVEDA, INC., Wayzata, MN (US)

(21) Appl. No.: 14/281,029

(22) Filed: May 19, 2014

(51) Int. Cl. B01D 53/26; B01D 53/28

(52) U.S. Cl. CPC B01D 53/263; B01D 53/28

(57) ABSTRACT

A humidity controlling packet comprising a laminated liquid absorbing blotter material treated with a humidity controlling aqueous solution of defined water activity and laminated within a barrier permeable to water vapor, but impermeable to the humidity controlling liquid solution.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention

The present invention relates generally to the preservation of packaged products and specifically to the preservation of packaged goods that are processed at high speed and also require humidity control for extended shelf live.

II. Related Art

Most packages used in consumer and industrial channels are not hermetically sealed. There is a potential for air flow between the internal product and the associated inherent package headspace and between the package and the external environment. The rate of air exchange with the environment varies with the integrity of the package seals and materials as well as the exterior conditions to which the package is exposed. The impact on a wide array of consumable products is that the shelf life is shortened from what is desired and would otherwise be possible. In addition, the product quality relative to flavor, texture or overall performance will be impacted to varying degrees.

Non-hermetically sealed packages amount to approximately 95% of all consumer packages merchandised, thus, they undergo a constant exchange of moisture and oxygen between the internal product and the exterior environment. Selected products may react adversely to one or the other or both. The majority of consumable products have been formulated to prevent oxygen from impacting their quality. The harmful impact can come from the egress or ingress of water in the form of water vapor in many products. It has been found that mitigating moisture gain or loss can optimize product quality and performance and increase shelf life.

Certain products require storage in a defined relative humidity (RH) range for optimal performance. Examples would be tobacco products, herbs, pharmaceuticals such as medical marijuana, and certain food products. Although these products are typically packaged in a sealed container, frequently these containers leak. In certain instances the leaky container is purposeful and is designed to allow the egress of certain undesirable reaction products, for example, the carbon dioxide produced from freshly roasted coffee. Also, during use packages are opened and closed by the end user on a frequent basis. Naturally, frequent use allows the transfer of moisture to and from the environment.

As disclosed in U.S. Pat. No. 5,936,178 the relative humidity can be stabilized by the use of humidity control systems comprised of moisture permeable pouches containing specific salt solutions. Also, certain non-ionic solutions containing relatively low molecular weight molecules such as ethylene glycol, propylene glycol, glycerin, urea, guanidine, ethanol amine, simple sugars, or sugar alcohols may be employed. The choice of the solute and the solute concentration in the aqueous solution determines the solution water activity (aw). The water activity of a solution will equilibrate with the surrounding atmosphere until the relative humidity (RH) is equivalent to the water activity multiplied by 10² or (RH=aw×10²). For example, an aqueous solution of saturated sodium chloride with excess crystals, aw=0.75 will equilibrate with the moist air or dry air in a closed system until a relative humidity of 75 percent is achieved.

While incorporating humidity control packets such as those described in U.S. Pat. No. 5,936,178 and U.S. Pat. No. 6,921,026 B2 into the required product has been shown to be a very effective method to control RH, there are instances where there is not sufficient space for the soft packet in the package. Also, adding a soft liquid filled packet to a product which is being filled at a high rate such as a rate in excess of 300/minute has proved to be a technical hurdle. The laminated blotter packet of the present invention has successfully solved these problems by providing the mechanical strength and dimension required for high speed filling applications.

### SUMMARY OF THE INVENTION

The present invention provides a hydrophilic blotter material that is treated with an aqueous solution of defined water activity. The solution includes water, salts, and neutral molecules at such a concentration as to define the water activity and hence associated relative humidity.

The hydrophilic blotter material includes a woven or non-woven material such as cellulose, rayon, cotton, or other polymeric material treated in such a fashion as to enable it to readily absorb aqueous solutions.

The solution treated blotter material is then laminated between layers of permeable barrier film that will transmit moisture vapor but not liquid solution. The water vapor transmission rate (WVTR) is determined by the type of barrier used, its thickness and porosity. The moisture transferred is also determined by the area of the barrier exposed to the solution. It has been shown that a WVTR of about 10 grams water per 100 square inches over 24 hours provides good results for this device. Barriers that may be employed include polyvinylchloride, fibrous polyethylene (TYVEK®), cellophane, polycarbonate, thin polyolefin, polyamide, oriented polystyrene, polyfluorocarbon, or polyester such as Hytrel® laminated onto a suitable substrate such as paper. In addition, the barrier may comprise nylon film, such as Capran®, styrene-butadiene copolymer such as K-Resin®, cellulose acetate, polyethylene terephthalate (PET), ethylene vinyl acetate, or ethylene vinyl alcohol.

One critical aspect of this invention is the ability to produce the treated blotter concept at high speed that translates to much lower cost than alternative delivery systems. The standard production method is to place the liquid along with a necessary small volume of headspace inside a pouch that is then sealed shut. This standard approach is used for nearly all product delivery systems such as fast food condiments where the entire volume of product must be expelled from the package. Many other similar pouches are produced commercially. In the delivery system of the present invention, the product is not designed to be expelled from the pouch. Production for condiment pouches for example is at a relatively slow speed because of the sequential filling and sealing required.

Because the technology of this blotter delivery system involves passage and/or release of water vapor only, an alternate system became available. The delivery system packaging′ of the present inventive concept as described herein is one in which treated blotter packets can be produced at speeds in excess of 700 units per minute. This rate is far beyond that of alternate packaging concepts such as the liquid-in-a-pouch type referred to previously. Further, the ability to produce a continuous string of these blotter packets at such a high rate and enable application of the packets in other product packaging later at speeds in excess of 300 units per minute has allowed the production to be very efficient at a low cost per unit. The usage of a blotter to carry the humidity control product allows the expelling of any excess headspace and enables the permeable packets to be extremely thin compared to alternative liquid-in-a-pouch concepts. The described product blotter delivery system can be incorporated into a variety of products because of its very thin profile. One example is the ability to include a packet in a cigarette package without the requirement of increasing the dimensions of the existing package. This is critical when one looks at the incremental cost of adding this feature.

### BRIEF DESCRIPTION OT THE DRAWINGS

The foregoing features and advantages of the invention will become apparent to those skilled in the art from the following detailed description of one or more preferred embodiments, especially when considered in conjunction with the accompanying drawings in which like numerals depict like parts:

FIG. 1 is a schematic drawing showing a process for assembling treated blotter packets in accordance with the invention; and

FIG. 2 illustrates the incorporation of a treated blotter humidity control packet into a cigarette package.

### DETAILED DESCRIPTION

The detailed description of examples or illustrative embodiments is intended to illustrate representative examples of the inventive concepts and is not intended to exhaust or limit the scope of those concepts. The examples are to be read in connection with the accompanying drawings, which are to be considered part of the entire written description of this invention.

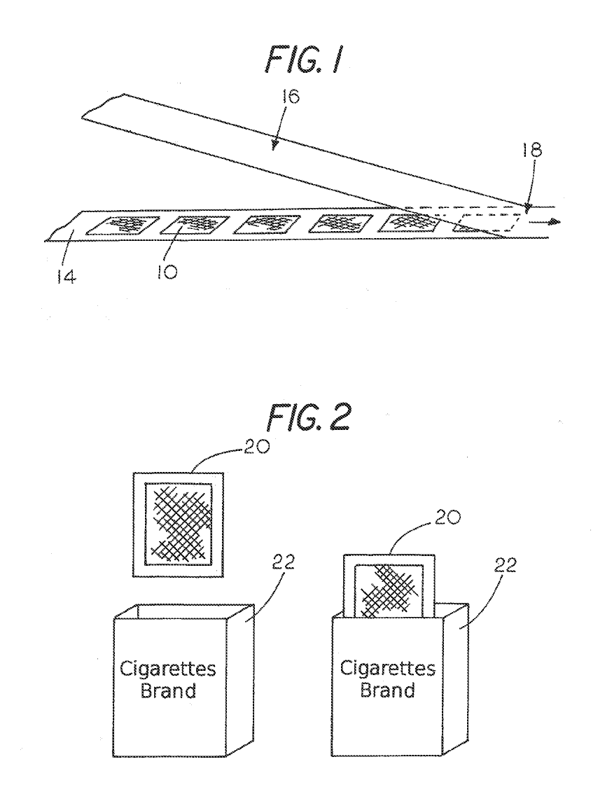

A water and salt solution is prepared for treating an absorbent blotter material using the desired salt concentration to deliver a desired relative humidity. For example, a solution of sodium chloride 33% and water 67% with excess sodium chloride will maintain a relative humidity of 75% in a sealed package of the appropriate size. This solution is then applied to an absorbing blotter material such as cellulose, cotton or rayon material of the appropriate dimensions. The blotter material is laminated between layers of semi-permeable polyester elastomer film material such as Hytrel® or a moisture barrier such as TYVEK® that will transmit water vapor, but not the liquid humidity controlling solution using the appropriate equipment as shown in FIG. 1.

FIG. 1 depicts a schematic view of an assembly process for assembling treated blotter packets in accordance with the invention. The packets have a core of absorbent blotter material as at 10 which is subjected to a quantity of humidity control liquid using a liquid application system (not shown), which operates in a well-known manner. The cores of absorbent blotter material 10 have been sized according to the packets being produced and have been applied to a lower or bottom laminate layer in spaced sequence. After the application of the humidity control liquid, an upper or top laminate film layer 16 is applied and preferably heat seated to the lower laminate layer around the cores as at 18.

As shown in FIG. 1, for many applications, it is best to maintain the laminated blotter packets on a roll or bandoleer to facilitate separation and incorporation into a final package at fast process line speeds. Techniques for high speed lamination are well known in the art.

As shown in FIG. 2, the finished packets 20 may be sequentially separated and inserted into consumer packaging as illustrated by cigarette packages 22, which exemplify a package in which humidity control is desirable.

Illustrative examples will be presented regarding the production of treated absorbent blotter packets in accordance with the invention.

### EXAMPLES

### Example 1

### Moisture Transfer Through Sealed Containers (without Packets)

A commercially produced and sold tobacco product contained within a sealed plastic container was monitored for moisture loss. Experimental conditions included a test chamber at 10% relative humidity and ambient temperature. These conditions are very typical of winter months in northern latitudes. This study showed the package lost 0.25 grams of water in a 15 day test period or approximately 10% of the moisture within the product.

Another test measured the moisture loss of cigars with overwraps. These cigars, 14% moisture and a water activity of 0.66, were stored in a 10% relative humidity chamber at 70 F. This weight loss study showed that at average ambient conditions, the product would lose 2 grams of moisture in 90 days which resulted in unacceptable quality.

### Example 2

### Cigarette Pack Moisture Control (with Packets)

A laminate package insert (3.0×1.88×0.024 inches) was formed by adding 1.2 grams of humidity controlling solution with a 0.69 water activity to a rayon (Suominen@160020) blotter and sealed in Hytrel®. The blotter dimensions were 2.19×1.06 inches. This laminated insert was placed inside the cigarette pack where the interior foil cigarette wrapper separated this Hytrel insert from the cigarettes. This insert was sufficiently thin that the original dimensions of the cigarette pack did not require modification. The effective water activity quality range for this product was determined to be 0.69 to 0.62 or about 0.9 grams of moisture loss per pack. Between 0.69 and 0.62 water activity, the laminated insert will transfer about 0.6 grams of moisture. It has been observed that in a 10% RH environment at ambient temperature, the cigarette pack will lose about 0.1 gram moisture per month. With the humidity controlling laminated insert in the cigarette pack, the added moisture will extended the shelf life about 6 months.

### Example 3

### Smokeless Chewing Tobacco (with Packets)

Chewing tobacco has a high moisture content of about 50% with a water activity of about 0.87. Consumer testing has established that a water activity of 0.80 would be the lower limit for consumer acceptance. The moisture loss between aw 0.87 and 0.82 is about 10% of the tobacco weight or 3.0 grams of long cut chewing tobacco. Also, it has been shown that freshly packaged chewing tobacco in a sealed container will lose 0.24 g of moisture/month at 77 F and 60% RH. If the container is opened and closed, it will lose about 0.1 gram moisture/day in a dry 10% RH environment. A humidity controlling laminate (1.75×1.63×0.03 inches) was formed by adding 2.0 grams of the humidity controlling salt solution (0.86 water activity) to a rayon (Suominen® 160020) blotter 1.50×1.38 inches and sealed in Tyvek® moisture barrier film. Horizontal packaging equipment is used to manufacture this laminated insert. The laminate was inserted in the bottom of the tobacco container and separated from the tobacco by a friction fitted porous barrier. It has been found that the moisture controlling laminated insert will lose 1.3 grams of moisture between water activity 0.87 to 0.82. This extends the effective tobacco shelf life about 5 months depending of the storage conditions.

### Example 4

### Humidity Control with Packets and Oxygen Scavenger

A humidity controlling solution with 0.75 aw was prepared (water 61.9%, sodium chloride 21.9%, sodium erythrobaye 15.8%, 50% sodium hydroxide 0.2%, potassium sorbate 0.05%, and ferrous sulfate pentahydrate 0.15%).

Five grams of this solution was place on an 8 square inch rayon blotter along with 0.8 grams of elemental iron (200 mesh) and laminated with TYVEK Oliver Tolas 1059H.

The oxygen absorption was measured by placing this laminated insert into sealed metal foil pouches with 250 ml of air (21% O₂) and testing for oxygen at time intervals. The sealed containers were held at ambient temperature (70 degrees F.). After 14 days the oxygen level had decreased to 5% and after 26 days 0.2%. The environment of the container was held at 75% RH with oxygen scavenging.

### Example 5

### High Moisture Gummy Vitamins

A popular delivery system for vitamins and minerals is the soft chewy fruit flavored gummy matrix. These fruit pieces are comprised of corn syrup, sucrose, gelatin plus the nutrients and flavor. The water activity of these fruit pieces is about 0.69 which is required for the soft texture. Studies show a decrease in water activity of 0.14 (20%) is associated with a moisture loss of only 4%, but it caused a marked change in product texture. A humidity control laminate containing 5 grams of humidity control solution with a water activity of 0.69 (water 62.7%, NaCl 15.6%, NH4Cl 15.6%, glycerin 5.9, citric acid 0.1%, polysorbate 60 0.1%) placed in the gummy vitamin container will provide 3 grams of water at 69% RH extending the product shelf life for 75 grams of gummy vitamin pieces. The added moisture maintained product quality in an opened jar for up to an additional month, depending on the opening frequency and external relative humidity.

### Example 6

### Laminated Blotter Production

The Laminated Blotters can be Produced on a horizontal Circle® Machine (Green Bay, Wis.). The bottom layer of the laminate, comprised of moisture vapor permeable film such as Hytrel or Tyvek®, is fed into a multi-lane machine. The width of the laminate is determined by the cut dimensions adjusted on the machine. The blotter material is fed onto the bottom film at such a rate and size so as to provide an area to heat seal all four sides of the laminate. The humidity control solution is dispensed onto the blotter in such a fashion not to leak into the heat seal area. The top moisture permeable laminate layer is fed onto the blotter and heat sealed to the bottom layer totally enclosing the blotter in the moisture permeable barrier. This laminate may be cut lengthwise only to form rolls of laminated blotter or cut into individual units.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A humidity controlling container insert comprising a laminated liquid absorbing blotter material treated with a humidity controlling aqueous solution of predetermined defined water activity that determines the controlled relative humidity in the container, said solution being selected to control relative humidity at a value determined by requirements of container contents and laminated between barrier layers, wherein said barrier layers are film that is permeable to water vapor, but impermeable to the humidity controlling aqueous solution.

2. A continuous line of humidity controlling container inserts, each insert comprising a laminated liquid absorbing blotter material treated with a humidity controlling aqueous solution of predetermined defined water activity and laminated between barrier layers, wherein said barrier layers are film permeable to water vapor, but impermeable to the humidity controlling aqueous solution and wherein a plurality of said container inserts are sequentially spaced along a roll or bandoleer prior to separation and insertion into a final product requiring humidity control.

3. A humidity controlling container insert as in claim 1 wherein the blotter material treated with said humidity controlling aqueous solution comprises woven or non-woven cellulose, rayon, or cotton so as to facilitate liquid absorption.

4. A humidity controlling container insert as in claim 1 wherein the barrier layer film is selected from the group consisting of polyolefin, polyester, polyester elastomer polyamide, urethane, polyvinylchloride, polyvinyl acetate, polyvinyl alcohol and chemical derivatives thereof.

5. A humidity controlling container insert as in claim 1 wherein the humidity controlling aqueous solution that controls water activity/relative humidity is comprised of water and various salts at a concentration that determines the water activity and thus the relative humidity in a container provided with said insert.

6. A humidity controlling container insert as in claim 5 wherein said salts are selected from the group consisting of combinations of the cations sodium, potassium, lithium, ammonium, quaternary ammonium, calcium, magnesium, and anions such as chloride, bromide, citrate, lactate, formate, sulfate, acetate, malate, phosphate and tartrate.

7. A humidity controlling container insert as in claim 1 wherein the humidity controlling aqueous solution that controls water activity comprises water and certain non-ionic molecules selected from the group consisting of propylene glycol, glycerin, ethanol amine, xylose, glucose, sucrose lactose, fructose, sugar alcohols such as xylitol, mannitol, and sorbitol.

8. A humidity controlling container insert as in claim 1 wherein the humidity controlling aqueous solution that controls water activity comprises non-ionic molecules combined with the salt solutions to form aqueous solutions for controlling the humidity within the container.

9. A humidity controlling container insert as in claim 1 wherein the humidity is selectively controlled between 20% and 98%.

10. A humidity controlling container insert as in claim 1 wherein the laminated insert is selectively designed to provide a desired relative humidity protection for one of a variety of humidity sensitive substances selected from tobacco, foods, herbs, cannabis, pharmaceuticals, and nutritional substances.

11. A humidity controlling container insert as in claim 1 wherein one or more oxygen scavenging components are included.

12. A humidity controlling container insert as in claim 11 wherein the oxygen scavenging components are selected from the group consisting of ferrous sulfate, elemental iron, ascorbic acid, sulfite, erythrobic acid and are included in the humidity controlling solution.

13. A humidity controlling container insert as in claim 1 wherein the pH of the solution is further controlled by the addition of acidic or basic substances.
